(19) United States
(12) Patent Application Publication
(10) Pub. No.: US 2002/0021675 A1
(43) Pub. Date: Feb. 21, 2002

(54) System and method for packet network configuration debugging and database

(75) Inventor: Anja Feldmann, Saarbruecken (DE)

Correspondence Address: AT&T CORP., P.O. BOX 4110, MIDDLETOWN, NJ, 07748, US

(73) Assignee: AT&T Corp.

(21) Appl. No.: 09/907,733

(22) Filed: Jul. 18, 2001

Related U.S. Application Data
(63) Continuation of application No. 09/692,276, filed on Oct. 19, 2000.
(60) Provisional application No. 60/160,446, filed on Oct. 19, 1999.

(51) Int. Cl. H04L 12/56

(52) U.S. Cl. 370/254; 370/401

(57) ABSTRACT

The present invention discloses a method and system of extracting relevant information from a collection of router configuration files and using the information to populate a data model. Each section of the router configuration files is read and parsed in a pre-specified order reflecting the dependencies within a single configuration file. Customized information about the network nodes, not reflected in the router configuration files, can be input as well into the data model. Consistency checks and policy checks can then be performed against the data. The data model provides a network-wide view of the topology and configuration, which is crucial for a variety of network engineering tasks.

### FIELD OF THE INVENTION

The present invention relates generally to packet-switched networks. More particularly, the present invention relates to analysis of the configuration of packet-switched networks.

### BACKGROUND OF THE INVENTION

The operation of a packet-switched network, such as an Internet Protocol (“IP”) network, depends on the configuration of a plurality of routers. In traversing a router, a packet is read from an interface and is either directed to one or more interfaces or discarded. The routers often utilize multiple distributed routing protocols to control the flow of traffic through a packet-switched network. Ultimately, the efficient operation of the network depends on the configuration of individual routers. Router configuration involves selecting a wide range of parameters that relate to resource allocation (e.g., link bandwidth and buffers), routing protocols (e.g., BGP policies and OSPF weights), and access control (e.g., packet filters). Network operators configure routers as part of installing new equipment, enabling new features, and adapting to network failures and shifts in user demands.

Configuring a large packet-switched network is extremely difficult, for a variety of reasons.

First, the correct operation of the network depends on consistent configuration across a collection of routers. Correct configuration of each individual router does not necessarily ensure the correct operation of the network. For example, two directions of a point-to-point link in an IP network should belong to the same OSPF area. Similarly, a BGP session requires compatible configuration of the pair of BGP speakers.

Second, changes in the configuration of a single router can have network-wide implications on the flow of traffic. For example, increasing a link's OSPF weight could substantially increase the traffic load in some other part of the network. Some BGP configuration errors can cause disruptions in service in other parts of the Internet. Evaluating the impact of changes in routing policies requires a network-wide view of the topology and traffic demands. This has become increasingly important with the emergence of customers and applications that require performance guarantees, and the growing complexity of peering relationships.

Third, router vendors offer a wide array of configuration commands and options. For example, Cisco's Internet Operating System (IOS) has over 600 commands. Configuration options and default parameter settings vary across different router products and IOS versions, and multiple types of routers may be active in the network at the same time. Configuring a large IP network requires substantial domain knowledge and attention to detail. In practice, routers are configured by a small number of local experts.

Fourth, large IP backbones experience frequent changes in network topology and configuration. Routine events such as the addition of a new customer or peer, the installation of a new link, the enabling of measurement functions, and the upgrading of software typically require changes in router configuration. In addition, link failures and traffic fluctuations may require the network operators to tune the configuration of the routing protocols to alleviate congestion.

Fifth, network operators have limited tools to aid in configuring a large backbone network. Configuration typically involves manual interaction with a command-line interface, or a primitive Web interface. Basic tools provide templates for certain configuration operations, such as the provisioning of new customers. Support for large backbone networks, however, is fairly limited. This problem is exacerbated by the fact that commercial configuration tools (e.g. Cisco's ConfigMaker, Fast Step, or Netsys) often lag behind the release of new high-end routers and advanced features.

Accordingly, there is a need in the prior art for new ways of building a network-wide view of a packet-switched network and for analyzing the configuration of the network for possible errors and inconsistencies.

### SUMMARY OF THE INVENTION

The present invention discloses a method and a system for providing a network-wide view of topology and configuration information in a packet-switched network. In a preferred embodiment of the present invention, an abstract data model is provided that comprises data objects containing information relating to connectivity, addressing, and routing in the packet-switched network. The data model may be populated from a number of network information sources; for example, the relevant information may be extracted from a collection of router configuration files. The data model can be easily extended with new configuration commands and with information from other sources that would not be available from a router configuration file, such as the geographic location of the particular router. In accordance with an embodiment of the present invention, each section of the router configuration files is read and parsed in a pre-specified order reflecting the dependencies within a single configuration file and across multiple configuration files. Consistency checks and policy checks can then be performed against the data. Unlike prior art tools, the present invention is easily customizable to suit the needs of the network provider and can be readily modified to take advantage of new changes to configuration file formats.

The present invention advantageously provides a network-wide view of configuration information that is necessary for predicting how configuration and topology changes would affect the flow of traffic. The abstract nature of the data model also is useful for hiding low-level configuration details that do not affect the resource-allocation policies at the network-level.

These and other advantages of the invention will be apparent to those of ordinary skill in the art by reference to the following detailed description and the accompanying drawings.

### BRIEF DESCRIPTION OF THE DRAWINGS

FIG. 1 is a conceptual representation of a data model, in accordance with a preferred embodiment of the present invention.

FIG. 2 is a diagram of an IP router and its components.

FIG. 3 is a diagram of a router card with three port adaptors, each with multiple ports.

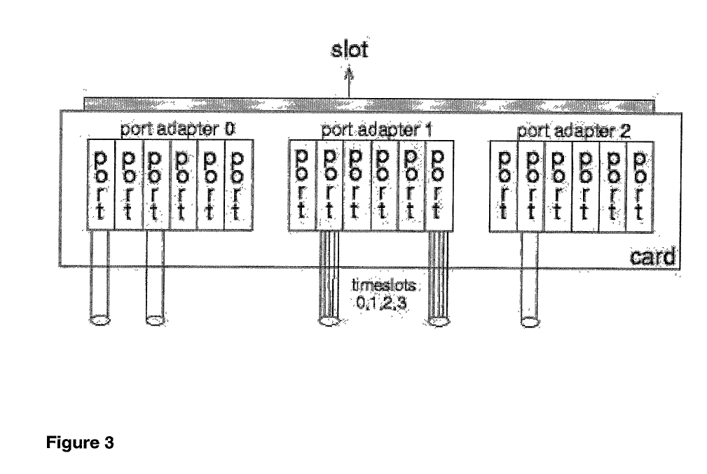

FIG. 4 is a diagram illustrating a software architecture adapted for processing router configuration files and populating the data model, in accordance with an embodiment of the present invention.

FIG. 5 is an example of an IP router configuration file.

FIG. 6 is pseudo-code illustrating the processing of the router configuration files, in accordance with an embodiment of the present invention.

FIGS. 7A and 7B set forth examples of error messages generated in accordance with a preferred embodiment of the present invention.

### DETAILED DESCRIPTION

In the following sections, a preferred embodiment of the present invention is described which enables a network operator to create an abstract network-wide view of network configuration for an IP-based network. Section A describes a preferred network data model. Section B describes methodologies of populating the data model. Section C describes using router configuration files to populate the data model and the sorts of customized error-checking that can be accomplished using the data model.

A. Data Model

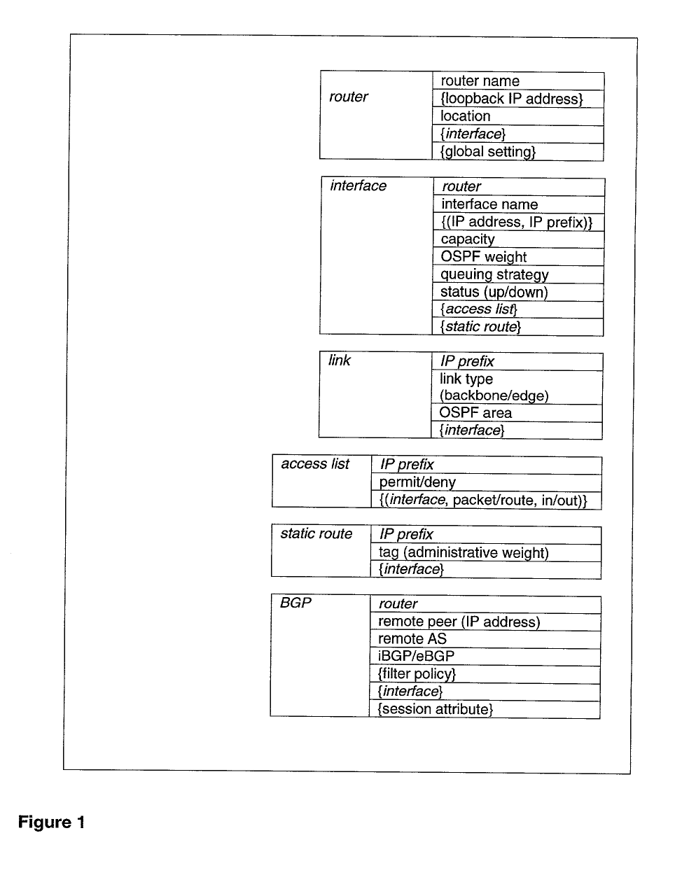

With reference to FIG. 1, a preferred network data model is set forth that can include elements for the physical components of the network (routers, interfaces, and links), typical known routing protocols (static routes, OSPF, and BGP), and access control (packet filters and route filters). Each data object has attributes for key configuration parameters and for linkage to other objects. The data model focuses on the operation of routers within a single autonomous system (AS) which, as is known in the art, is a collection of routers and links managed by a single entity such as a company, university, or Internet Service Provider (the Internet itself consists of thousands of autonomous systems). The data model advantageously represents the network at a level of abstraction that is appropriate for traffic engineering. The data objects and attributes described in further detail below are not meant to be exhaustive. It is an important advantage that the data model represent network operation at the right level of abstraction—as well as have the flexibility to permit additional parameters as is required by changes to the network as well as the needs of the particular network operator.

Router:

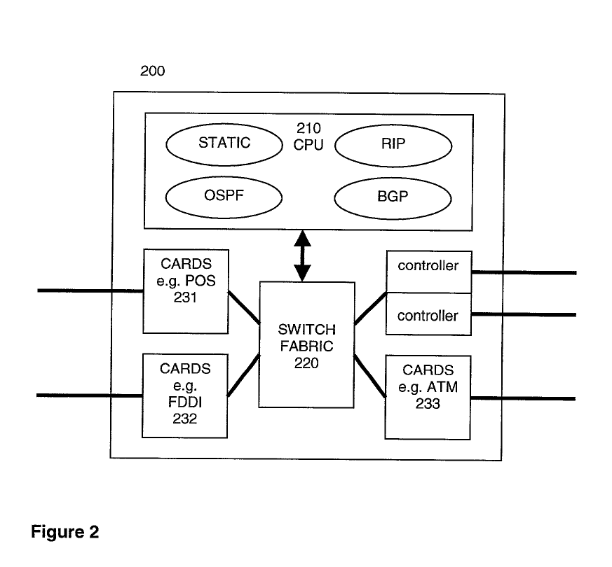

A router in a packet-switched network receives incoming packets and directs them toward their destination. As shown in FIG. 2, an IP router 200 typically consists of a route processor 210, a switching fabric 220, and a collection of interfaces 231, 232, 233, etc. The route processor 210 is identified by one or more loopback IP addresses, assigned by the network operators as part of configuring the router. The processor 210 combines information from the intradomain and interdomain routing protocols to construct a forwarding table that is used to select the next-hop interface for each incoming packet. Rather than forcing each IP packet to travel through the route processor, most high-end routers have interfaces that can perform packet forwarding: the incoming interface directs the switching fabric to forward the packet to the appropriate outgoing interface. Although most traffic travels directly from an incoming interface to an outgoing interface, certain packets must be directed to the route processor. For example, the route processor typically handles packets that have IP or TCP options enabled and packets with expired time-to-live fields. The route processor handles any packets sent to or from the router's various interfaces, including the router's loopback IP addresses. This includes the routing protocol traffic exchanged with other routers, e.g. link-state updates from neighboring routers required by OSPF; BGP sessions with other BGP speakers (as described in further detail below in the section on BGP data objects). Routine management functions also introduce traffic to and from the route processor, e.g. the route processor may respond to ping requests, SNMP queries, or telnet sessions initiated by network operators wishing to configure or reboot the router.

The data object for routers reflects the above functionality by including attributes for the interfaces, the router's loopback IP address(es), and its global settings which reflect what applications (such as a “finger daemon or routing protocols) may run on the processor. Attributes for the router's name and geographic location can also be included to help the network operator keep track of the assets in the network.

Interface:

An interface on a router receives incoming packets and queues and transmits outgoing packets. Each interface has a name that indicates its position in the router. FIG. 2 shows how a typical interface physically resides on a card that connects to a slot in the router's switching fabric. A single card consists of one or more port adaptors (using the terminology of Cisco's IOS). A port adaptor has one or more ports that each connect to an underlying transmission medium, such as a fiber optic cable or an ATM link. In some cases, a port corresponds to an interface to a link connecting two or more routers. In other cases, the capacity of a single transmission medium may be subdivided into multiple time slots. For example, a port may subdivide its bandwidth into 16 time slots, each with 1/16 of the bandwidth. The router could be configured to assign one or more of these time slots to a single interface to a link. The abstraction is provided by a controller that directs outgoing packets to the time slots associated with this interface. Similarly, a single port to a layer-two ATM link may support multiple permanent virtual circuits, each corresponding to a different interface at the IP layer.

Accordingly, interfaces are modeled as having attributes representing the interface's primary IP address, with one or more secondary IP addresses, each address associated with a particular prefix. For example, an interface may have IP address 10.34.56.77 in the prefix 10.34.56.76/30. Associating an interface with multiple IP addresses provides a way to overlay multiple links or eBGP sessions on a single interface. An interface data object also has a capacity attribute that depends on the bandwidth of the transmission medium. For a time-slotted transmission medium, the capacity depends on the number of time slots that have been allocated to the interface. Knowing the capacity is important for engineering the flow of traffic in the backbone. The interface data object also has attributes for its OSPF weight and a queuing strategy (as further described below). An additional attribute indicates the status of the interface, i.e. whether it is “up” or “down.” An interface may be down due to a failure or because the interface is in provisioning and has not yet been enabled to carry traffic.

Link:

Neighboring routers exchange traffic over links. Each link is identified by an IP prefix, and each participating interface has a unique IP address with this prefix. See, e.g., F. Baker, ed., “Requirements for IP Version 4 Routers,” RFC 1812, IETF Network Working Group, June 1995. For example, the prefix 10.34.56.76/30 consists of the IP addresses 10.34.56.76, 10.34.56.78, and 10.34.56.79. The addresses 10.34.45.76 and 10.34.56.79 are typically reserved for the network address and the broadcast address, respectively. Addresses 10.34.56.77 and 10.34.56.78 can be used to identify the two ends of a bidirectional, point-to-point link. A shared medium, such as an Ethernet or an FDDI ring, may include more than two interfaces, resulting in a prefix with a shared mask length. The IP addresses of the interfaces are assigned by the network operator as part of configuring the router. Interface IP addresses do not necessarily have any relationship to the loopback IP addresses of the incident routers. Likewise, the IP addresses of various interfaces at a router are not necessarily related.

Each link data object, then, can be defined by an IP prefix attribute, which includes one or more IP addresses. Each link can be associated with a type—“backbone” or “edge”—that depends on the number of interfaces. A backbone link connects two or more routers inside the AS, and an edge link connects to a neighboring customer or peer (network operators have complete control over each backbone link; configuration of an edge link, however, requires coordination with the neighboring customer or peer). Thus, an edge link has exactly one interface inside the AS, and a backbone link has two or more interfaces. For example, a large AS could have multiple edge links that connect to customers, such as business or university campuses, small regional providers, and local services like a modem bank for dial-up users or a Web-hosting complex. The AS may also have edge links that connect to other large providers via dedicated connections or public Internet exchange points.

The AS typically employs an intradomain routing protocol, such as OSPF or IS-IS, to select paths across the backbone. See, e.g., J. Moy, “OSPF Version 2,” RFC 2328, IETF Network Working Group, April 1998. Each backbone link is associated with an OSPF area (in contrast, edge links do not typically participate in the intradomain routing protocol). Under OSPF and IS-IS, each interface to a backbone link has an integer weight, assigned by the network operator. The routers exchange this information and compute shortest paths, where path length is defined as the sum of the link weights. Since these protocols typically use flooding to propagate link-state information, they do not scale to large networks. Therefore, large ASes typically introduce a routing hierarchy by dividing the backbone into multiple areas. Each backbone link belongs to a single OSPF area, and each interface to a backbone link has an OSPF weight. This structure is reflected in the data model of links and interfaces, respectively. Ultimately a router combines the information from the intradomain routing protocol (OSPF, IS-IS) with the interdomain reachability information (from static routes and BGP) to construct a forwarding table.

Static Route:

Based on the forwarding table, the router can associate a packet's destination IP address with one or more “next-hop” interfaces. The scalability of the Internet routing infrastructure depends on the aggregation of IP addresses into prefixes, each consisting of a 32-bit length IP address and a mask length (the terms prefix and IP network are often used interchangeably). Static routes provide a simple way to associate destination prefixes with edge interfaces. For example, suppose the AS has an edge interface to a customer with prefix 10.2.3.0/24. Then, the incident router could be configured with a static route to bind the prefix to the edge interface. This enables the customer to receive traffic destined to 10.2.3.0/24 without participating in an interdomain routing protocol. To send traffic to the rest of the Internet, the customer could configure its network to direct any outbound traffic to the edge link. This obviates the need for the customer to acquire detailed routing information about the rest of the Internet. A customer may connect to the AS with multiple interfaces to one or more routers for load balancing or fault tolerance. More generally, then, each static-route object concerns a particular prefix that is associated with a set of interfaces. The configuration of a static route ensures that the router knows to direct packets destined to this prefix to the appropriate next-hop interface. However, this does not ensure that the rest of the routers in the AS, and the rest of the Internet, know how to reach this destination prefix. To inform the rest of the network, the router can be configured to advertise the static route via an intradomain routing protocol (e.g., OSPF or interior BGP). The static route includes a tag (administrative label) that determines the attributes of these routing advertisements.

BGP:

The AS also learns about destination prefixes via dynamic routing protocols, such as BGP. BGP is a distance vector protocol that constructs paths by successively propagating reachability information. See, e.g., Y. Rekhter and T. Li, ed., “A Border Gateway Protocol 4 (BGP4)”, RFC 1771, IETF Network Working Group, March 1995. Each BGP advertisement concerns a particular prefix and includes a list of ASes along the path, as well as other attributes. BGP advertisements are exhanged over BGP sessions between pairs of routers. The two ASes would typically establish a BGP session between the incident routers; these routers are BGP peers. The ISP employs local policies to select a route for each destination prefix, and to decide whether to advertise this route to neighboring ASes. BGP policies can filter unwanted advertisements and assign local preferences, based on a variety of attributes. Then, the router executes the BGP decision process to select the best route to each destination prefix. BGP export policies determine whether, and what, to advertise to each BGP peer. Interior BGP (iBGP) sessions are used to distribute this information inside the backbone. A large AS may employ techniques such as route reflectors or confederations to avoid the overhead of having an iBGP session for each pair of routers (i.e., a full iBGP mesh). Each BGP data object corresponds to one end point of a BGP session. The attributes include the originating router of the BGP session and the remote end point of the BGP session. The remote end point is identified by IP address which may correspond to a particular interface or the loopback address. A BGP object also has a remote AS, a peer group, a set of filter policies, and set of session attributes, capturing the various configurable parameters of a BGP session. The iBGP/eBGP flag distinguishes between interior and exterior sessions; a session with a remote end point inside the AS is classified as an iBGP session. The BGP data object also includes a set of interfaces that define how the router reaches the remote end point to exchange BGP messages. Interior BGP sessions rely on an intradomain routing protocol (e.g., OSPF) to direct traffic to the remote end point. BGP sessions with other ASes usually depend on explicit configuration of a set of interfaces that can carry the traffic toward the remote end point. For example, the remote end point may be reachable via a directly-attached network. In other cases, the router could be configured with static routes that indicate how to direct traffic toward the remote end point.

Filter:

In addition to forwarding IP packets, an interface may perform various filtering functions. An AS may employ packet filters to control the traffic entering or leaving the backbone via a particular interface. Access lists identify which packets should be accepted or denied, based on fields in the IP headers such as source and destination addresses. To simplify operation, access lists are often specified using IP prefixes, which is reflected in the attributes of the access list data object. For example, consider an interface that connects to a customer that has been allocated a known block of IP addresses. Packets entering the backbone via this interface can be filtered based on a source IP address, and packets leaving the backbone via this interface can be filtered based on the destination IP address. These addresses should lie within the customer's range of IP addresses. Packet filtering helps detect spoofed source IP addresses and protects the customer from receiving traffic from unwanted sources. In addition, routers that participate in BGP may employ route filters to discard unwanted routing advertisements. A route advertisement consists of a destination prefix, an AS path, a next-hop AS, and a number of other attributes. Each BGP session can have route filters that discard advertisements based on any of these attributes. This plays an important role in protecting the AS, and the rest of the Internet, from misconfigured BGP policies in downstream routers. For example, suppose a customer connects to multiple service providers and mistakenly forwards advertisements from one large service provider to another. In the absence of route filtering, the two service providers may begin to exchange traffic via their common customer. An AS may also use route filters for load-balancing purposes. For example, suppressing certain advertisements from a neighbor on one or more BGP sessions allows the AS to direct traffic to alternate edge interfaces that may be less congested.

It should be kept in mind that the above model relies heavily on the reasonable assumption that IP addresses are unique. IP addresses are utilized to identify the relationship between objects in the data model: they are used to identify routers and interfaces and to associate these components with links, BGP sessions, and access-control lists. Using the same IP address for two active interfaces constitutes a serious mis-configuration of the network; assigning an existing IP address to an inactive interface is permissible but not advisable since a simple command to enable the inactive link could introduce a serious problem in the network. In fact, it is advantageous that duplicate IP addresses be flagged as an error, as described in further detail below.

Despite capturing the key components of an IP network, the above data model reflected in FIG. 1 does not cover all aspects of IP networking. For example, the data model does not cover all possible routing protocols (e.g., IS-IS, RIP, and MPLS). This is an advantage in that current tools are hampered by the substantial complexity in attempting to support all routing configurations. Rather than understanding and modeling all possible configuration options, the above data model seeks to capitalize on the remarkable homogeneity of operational networks, in terms of the link-level technologies, router types, and configuration options. By focusing on a limited set of configuration options applied in operational networks, this offers a significant reduction in complexity while still allowing the data model to be augmented with additional parameters as needed and/or as new features or commands are introduced into the network. For example, where the network operator decides to enable weighted RED (Random Early Detection) on an interface, a new parameter can be added to the interface object to represent the tunable parameters for WRED. Adding a new attribute to an existing object requires a minor extension to the network model. As another example, as the IP network undergoes a major architectural change such as the introduction of a new routing protocol (e.g., MPLS or multicast), new protocols can be represented by new data objects.

B. Populating the Data Model

Populating the network model requires information about the physical components in the network, as well as the configuration of the routing protocols and access lists. The information could come form a variety of data sources, for example:

The Simple Network Management Protocol (SNMP) can be used to retrieve MIBs (Management Information Bases) that summarize the state of the router, including basic traffic statistics. However, the MIBs typically do not provide the full details of the configuration of the routing protocols and access lists.

Active measurement tools, such as “traceroute” and “pathchar”, can be used to infer various properties of the network, such as the topology, routing, and link capacity without having access to the network equipment. However, these tools cannot glean the full range of configuration parameters that affect the flow of traffic through the network.

Passive monitoring of routing protocol traffic, such as BGP advertisements and OSPF link-state updates, provides an effective way to track the topology and routing state in the network. However, IP routing protocols do not convey information about link capacity, access control lists or BGP policies.

Router configuration files provide a detailed view of the configuration of the routers in the network, including information about physical and logical connectivity, link capacity, routing protocols, and access lists. However, router configuration files do not provide an up-to-date view of the current status of each of the components.

Ultimately, none of the techniques above provide a complete view of an IP network, and each can play an important role in tracking the state of an operational network. Still, router configuration files provide the most complete information—it is the same information available to the routers themselves. In addition, traffic engineering tasks often require network operators to modify the router configuration, which heightens the importance of checking that the router configuration files are correct and consistent.

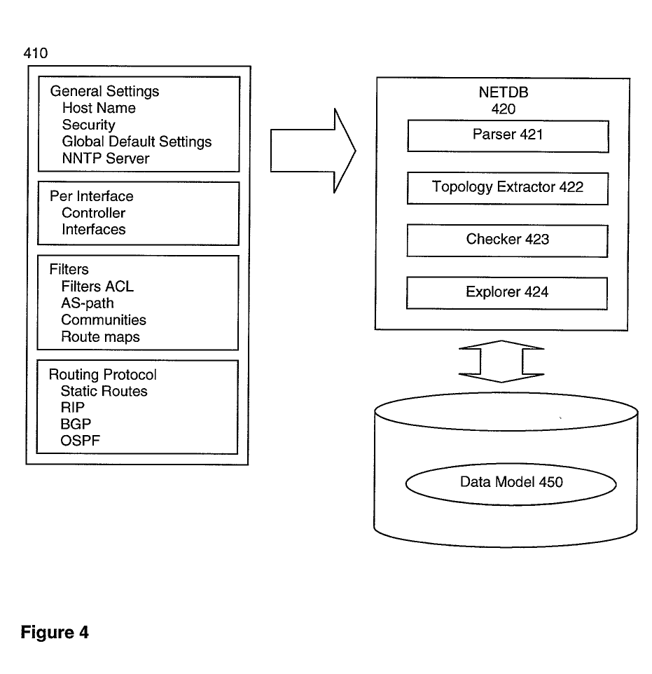

Thus, in accordance with one preferred embodiment of the present invention, FIG. 4 illustrates the process of populating the network model by processing router configuration files. It is important that the configuration data be available for all of the routers in the IP backbone and that the data be a consistent snapshot of the configuration in the network. Missing configuration files or files collected while the network undergoes significant reconfiguration will lead to incorrect error messages and mistakes in the network model. The router configuration files 410 are input to a program or process 420 running on some computing device. For example, where the configuration files are simple text files, it is advantageous to write the program 420 in a programming language such as Perl (although any programming language will suffice for purposes of the present invention). The program 420 further comprises a parser 421 to extract the relevant information from the configuration files 410 in order to populate the data model 450. As is further explained below, the processing order of the configuration files should be taken into account in order to take advantage of the dependencies within a single router configuration file and across multiple router configuration files. The data model can be implemented as hash tables, although other forms of data structures can clearly be utilized as well. Once the data model 450 has been populated, the program 420 can utilize the data in a number of different ways, e.g. by including a topology extractor 422 and a checker 423 to perform consistency checks on the data. An explorer 424 allows searching and browsing of the network structure, e.g., it advantageously can list all IP addresses in use within a given range of IP addresses; it can list all interfaces that use a given string in their description such as all VPN customers.

C. Processing Router Configuration Files and Error Checking

Commercial IP routers have a large number of configuration options that control the operation of the route processor and the various interfaces. For example, configuration determines which routing protocols are enabled (e.g., BGP, OSPF, IS-IS, RIP), as well as the selection of parameters (e.g., OSPF weight and area for each interface) and policies (e.g., import and export policies for each BGP session). Configuration also determines if and how the capacity of a single physical medium (e.g., an ATM trunk or channelized packet-over-SONET link) is partitioned across multiple layer-three links, and what packet filters are applied to incoming and outgoing traffic on a particular interface. Configuration of a router is achieved by applying commands to the router's operating system, e.g. Cisco's IOS; the commands can be specified via a command-line interface but they are typically uploaded to the router using a configuration file. In an operational network, the configuration files are routinely logged for backup purposes and, as such, provide a valuable snapshot of the state of the network.

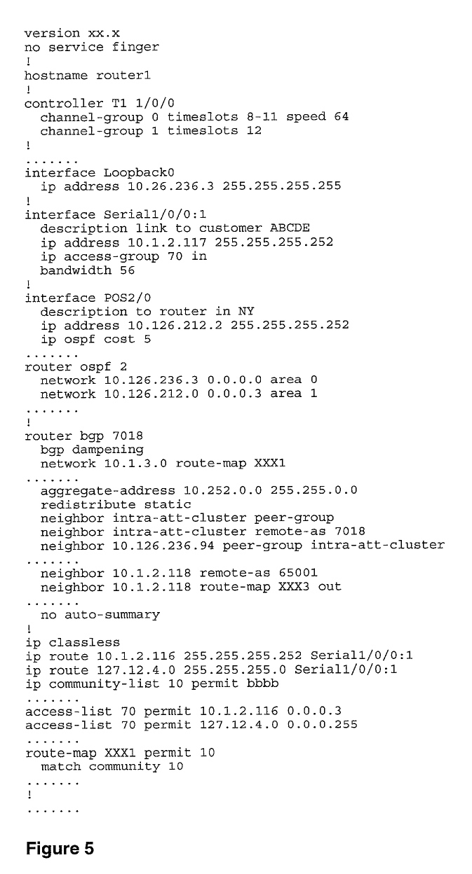

The process of parsing the router configuration file is clearly dependent on the structure of the configuration files. Router configuration files typically resemble a C program, and the configuration of an entire network is analogous to writing software for a distributed system. However, in contrast to most high level programming languages, existing router configuration languages have a very loose structure, limited unusual nesting, forward and backward dependencies, and a large number of syntactical elements. FIG. 5 shows an abbreviated example of a Cisco IOS router configuration file. The file includes global settings and a number of sections that relate to different aspects of the router. Global settings have implications for the entire router: e.g., FIG. 5 has four global settings—identifying the IOS version (“version xx.x”), disabling of the finger daemon (“no service finger”), the specification of the hostname (“hostname router1”), and the selection of classless interdomain routing (“ip classless”). Other global variables that are not specified in the file are assumed to have default values. In addition to global settings, the file includes a number of sections that relate to different aspects of router configuration. For example, FIG. 5 includes a “controller” section with a single controller entry and an “interface” section with three interface entries. The “LoopbackO interface” is associated with the route processor, whereas “Serial1/0/0:1” refers to the serial interface associated with channel group 1 of the T1 1/0/0 (slot 1, port adapter 0, and port 0). The controller section indicates that channel group 1 is bound to time slot 12 on the channelized T1. The Serial1/0/0:1 interface has IP address 10.1.2.117 in the 10.1.2.116/30 network (with the 30-bit mask specified by 255.255.255.252), and is associated with access-control list 70 that is specified later in the file. The access control list allows traffic for the 10.1.2.116/30 prefix and for the customer's prefix 172.12.14.0/24. The interface entry also includes a “description” statement, indicating that the link connects to customer ABCDE, and a “bandwidth” statement indicating the link capacity. The POS2/0 interface (slot 2, port adapter 0) refers to the packet-over-SONET backbone link that participates in the OSPF routing. FIG. 5 also has a “router” section with entries for the various protocols, such as OSPF, BGP, and static routes. Each statement in the OSPF entry associates a network address with an OSPF area. The Loopback0 interface (address 10.126.236.3 and a 32-bit mask) is associated with area 0 (the backbone area) and the POS2/0 interface (in network 10.126.212.0 with a 30-bit mask) is associated with area 1. The configuration file also specifies static routes that associate destination prefixes with a particular interface (e.g., the two “ip route” commands involving Serial 1/0/0:1). The BGP entry identifies the AS number (7018) and includes a number of commands that enable/disable certain features (e.g., route dampening and auto-summary) and control the aggregation of route advertisements involving certain IP prefixes (e.g., the “aggregate-address” command). In addition, the “neighbor” commands are used to associate the router with a particular route-reflector group for iBGP (e.g., the “neighbor” commands involving the intra-att-cluster) and to configure eBGP sessions with a router in another AS (e.g., the “neighbor” commands with IP address 10.1.2.118 in AS 65001). Each BGP session is associated with import and export policies, specified via route-maps that appear later in the configuration file.

Dependancies Within a File.

Interdependancies between various parts of the configuration file can result in unintentional errors. Two broad classes of errors can be identified—those that do not require any domain knowledge and those that do.

Domain-independent Violations.

First, there are errors—such as referencing undefined items or unused items—that do not require any domain knowledge. Many of the statements in a router configuration file refer to information specified in other entries. For example, the Serial1/0/0:1 entry refers to channel-group 1 defined in the 1/0/0 controller, and to access group 70 defined in the access-list section. Similarly, the “neighbor 10.1.2.118 route map XXX3 out” command refers to route-map XXX3. This introduces dependencies between the various parts of the configuration file that have implications on the population of the data model and the application of error checks. For example, the specification of interface Serial1/0/0:1 cannot be fully understood without parsing the controller and access-list sections. References to undefined items should be flagged as errors. For example, referencing an access group 60, instead of access group 70, should generate an error since this access-control list is undefined. On the other hand, specification of an interface Serial1/0/0:2 is not possible since controller 1/0/0 does not define channel-group 2.

In addition to missing or inconsistent definitions, the configuration file may define items that are never used. For example, the file might specify an access-list 80 that is never associated with an interface, or a route map XX4 that is never associated with a BGP session. These extra definitions do not affect the operation of the router and, hence, strictly-speaking are not errors. Still, generating warnings about unused items is useful to enable the network operator to remove unnecessary entries or fix mistakes. The unused entries could lead to erroneous assumptions or errors in the future. For example, the operator may associate a new interface with access-list 80 without realizing that some prefixes have already been associated with this access-control list. In addition, some unused entries may result from mistakes in configuring the router, e.g. the operator may have meant to type “70” rather than “80” to associate the access-list with Serial1/0/0:1.

Domain-dependent Violations.

Domain-dependent errors are generally concerned with the internal consistency of the router configuration. These errors arise from inconsistent definitions or dependence on default parameters. Although the router resolves such violations, the default handling may result in different behavior than intended by the human operator.

The router configuration language permits inconsistent definitions. For example, the bandwidth of an interface can be specified in multiple ways, including the “speed” field in the channel-group command and the “bandwidth” command in the interface entry. These two definitions may not be consistent with each other, or with the actual capacity of the underlying communication medium. This may have several negative consequences. First, inconsistent definition of interface capacity can result in incorrect SNMP statistics for link utilization, since utilization is computed relative to the link capacity. Second, the interface capacity plays an indirect role in defining other configurable parameters. For example, an interface participating in OSPF has a default weight (cost) that is inversely proportional to capacity. Inconsistent definitions can also arise from the global settings. For example, suppose that a configuration file did not include the “ip classless” statement. This could cause the router to discard packets destined to an IP prefix that is not aligned with octet boundaries.

Many configuration options have default parameter settings, dependence on which may be dangerous. Consider the process of configuring an interface to participate in OSPF. This involves assigning an OSPF weight in the interface section and an OSPF area in the router section. Inadvertently skipping either of these two steps has important consequences. If the router section does not assign an OSPF area, then the interface does not actually participate in OSPF (despite the fact that the interface entry includes an OSPF weight). On the other hand, suppose that the router section does assign an OSPF area. Then, the link does participate in OSPF, but if the interface entry does not assign an OSPF weight, then a default value is used (inversely proportional to interface capacity). However, the operator may have simply neglected to assign an OSPF weight. The use of the default value could have significant impact on the selection of routes in the network. Generating a warning is useful to prevent such mistakes.

Dependencies Across Files.

A correct and consistent configuration file for a single router is insufficient for correct operation of the rest of the network which depends on the interaction between the various routers. This interaction implies additional dependencies, conceptually similar to the dependencies that arise in linking a collection of software modules. Certain parts of the configuration file have network-wide significance: inconsistent definitions of global settings should be avoided, as well as inconsistent interfaces between routers.

A configuration file contains many entries that have significance at the router level. For example, defining access-list 70 in one file does not affect any other router. Similarly, the same prefix could be associated with access lists in more than one router. For example, an ISP may connect to a customer over multiple edge interfaces at different routers; each of these interfaces may have an access list with the same set of customer prefixes. Other parts of the configuration file have network-wide significance. Consider a backbone link with interfaces on two routers. If the link participates in OSPF, then the two routers should agree on the selection of an OSPF area; otherwise the link cannot carry traffic. The two routers may need to agree on a variety of other configuration options (e.g., cyclic redundancy check algorithm). Similarly, the correct functioning of an iBGP session requires consistent configuration of the two end points.

On the other hand, dependencies can arise from inconsistent references to remote nodes. For an eBGP session, one of the two end points resides outside of the backbone, on a router controlled by another organization. This limits the opportunity to check the consistency of the configuration. In some cases, an ISP has multiple eBGP sessions to the same remote end point (i.e., the same remote IP address). These eBGP sessions should refer to the same remote autonomous system. For example, suppose one router has the statement “neighbor 10.1.2.118 remote-as 65001” and another router has the statement “neighbor 10.1.2.118 remote-as 65002.” This would be a mistake. If two configurations refer to the same object, they should have the same view of the object. In fact, this observation can be applied in a variety of situations, including iBGP sessions where the remote end point resides inside the autonomous system.

The dependencies across configuration files have several important implications. First, the dependencies within a file enables the identification of the relationships between the router, interface, access-list, and static route objects. For example, an interface is associated with a particular router, a set of access lists, and a set of static routes. This configuration information is spread throughout the file. Second, the dependencies between files can be exploited to derive abstractions such as links and BGP sessions that represent the physical and logical connectivity, respectively, between the various routers in the backbone. Third, the dependencies within and between files define a natural ordering for processing the configuration data as objects are created in the network model.

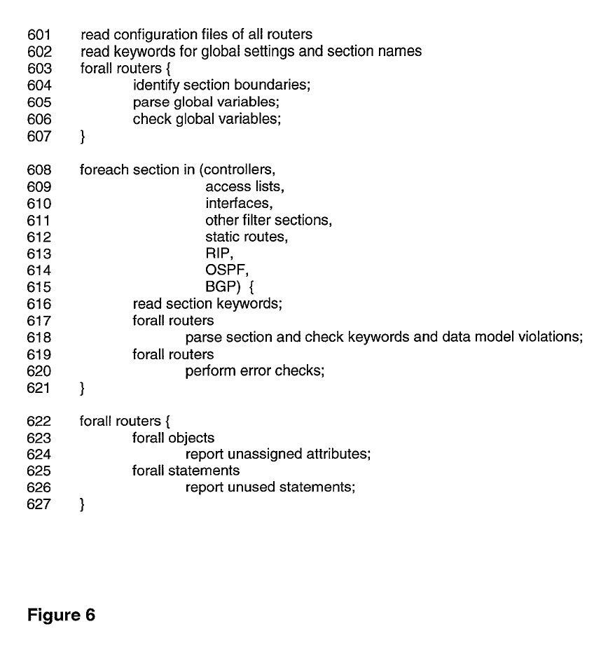

FIG. 6 sets forth pseudo-code describing in more detail a processing order which advantageously takes advantage of the dependencies described above. At step 601, the configuration files for all routers in the network are read through to create a table storing every configuration line. It is also advantageous to store router configuration keywords in one or more separate files that can be read at this time as well. It is also advantageous to input network-specific information that would be known to the network operator but might not be reflected in the configuration files—such as mappings between router names to cities, router names to kind of router (e.g., backbone router versus access router), and a list of peer AS numbers.

At step 602, data structures are created for global settings and sections controllers, interfaces, access lists, route maps (including communities and AS paths), static routes, RIP routes, OSPF routes, and BGP routes. The set of known global settings and section names is relatively small and, as set forth above, can be provided in an input file. Each section can include multiple entries. For example, the interface section in the configuration file in FIG. 5 has three interface entries. For each router and each section, a list of entries is stored. For each entry, the set of commands from the router configuration file is stored. For example, the interfaces for the sample configuration file of router “router 1” would contain

Loopback0|Serial1/0/0:1|POS2/0

while the command for “router1|POS2/0” would be

description1|ip address|ip ospf

where “|” is used as a field separator. The value associated with each attribute can be stored in a hash table. For example,

router1|Pos2/0|ip address

would map to

10.126.212.2 255.255.255.252

An error is generated upon encountering an unfamiliar global setting or section name.

At steps 603-607, the section boundaries are identified and the global settings parsed and checked. It is also checked whether all of the desired global variables have been specified. As part of processing each global setting, the associated parameters can be assigned to a data model, which is described in more detail below. This process repeats for all of the routers.

At steps 608-621, each of the sections is parsed, one at a time, across all of the routers. In accordance with an embodiment of the present invention, the processing order of the sections derives from the above-mentioned dependencies—e.g. in the case of a typical IP network, as set forth in lines 608-615, the controller sections are first parsed, next the access lists, next the interface sections, next the other filter sections, next the static routes, RIP, OSPF, and finally BGP. This processing order is advantageous in that it takes into account the dependencies within a single router configuration file and across multiple router configuration fields. Earlier sections do not depend on later sections (e.g. a controller specification does not depend on the access lists). Processing the sections in the order of the dependencies simplifies the process of populating the data model and identifying errors. Often a single error such as an incorrect interface IP address can manifest itself in multiple places in the configuration files. Respecting the dependencies between sections permits this aspect of the present invention to process the configuration files in a single pass and to identify errors at the lowest possible level. The process of populating the network model and identifying errors is simplified.

For example, consider an interface entry that refers to an access control list. By the time the interface entry is processed, all of the access-control lists have already been parsed. If the interface entry refers to a non-existent access-control list, an error can be flagged. Otherwise, the interface object can be associated with the existing access-control list. Similarly, consider the processing of the OSPF “network” statement that associated an IP prefix with a particular OSPF area. By the time the OSPF section is processed, all of the interface sections across all of the routers has also been already parsed. As such, which interfaces have IP addresses in this prefix is already known. If two or more interfaces fall within this prefix, the existence of a backbone link in a particular OSPF area can be inferred. Otherwise, an error can be flagged. If another router's configuration file has an OSPF “network” statement that applies to the same IP prefix, the two statements can be checked to make sure that they assign the same OSPF area.

In the process of parsing a section of the configuration file, data objects can be created, attributes assigned to existing data objects, and error messages generated, in accordance with the preferred data model described above. The raw text from the entries in the configuration files may also be included in the data object; such is useful to support browsing of the configuration file. The link objects are the only class of objects described that does not correspond to a section. Link objects are created as the interface entries within the interface section are parsed. For each interface entry, the IP prefix associated with the interface's IP address is considered. For the first occurrence of a prefix, a new link object may be created. The link object is associated with the IP prefix and with the IP address of the particular interface. If the same prefix is encountered in another interface entry, the existing link object is extended to include the IP address in the set of interface addresses.

Ideally, the interface object would indicate whether or not the interface can carry traffic. However, information about failed components is not available in the router configuration files. Such failure information could, however, be extracted from other sources of information, such as SNMP.

As suggested above, each section can have an input file that specifies the set of expected keywords, making the data model easily extensible. For example, a file for OSPF-related keywords could include the keywords:

1|ospf log-adjacency-changes

2|network

2|neighbor

The first field indicates whether the keyword should appear at most once (“1”) or can appear multiple times (“2”) in an entry. For example, a single OSPF entry can have multiple network and neighbor statements. A keyword may consist of multiple words, separated by white spaces. Hence, in parsing the configuration files, a longest-prefix match can be performed to associated each statement with the appropriate keyword. Customization also follows from the philosophy of extensibility; each section may have one or more input files that specify additional information or policies and default values.

After processing all of the sections, it is advantageous, at steps 622 to 627, to perform a few error-checking tasks. First, some of the data objects may have attributes that have not been assigned. For example, each backbone link should belong to an OSPF area, specified in an OSPF “network” statement. Hence, the link objects should be sequenced through and an error generated for each backbone link that does not belong to an OSPF area. Second, some statements in the router configuration file may not relate to any existing object. For example, a configuration file may define and access-control list that is never associated with a particular interface or BGP session. As part of populating the network model, it is advantageous to keep track of which statements have been applied one or more times. As the final stage of processing, warnings can be generated for statements that were never applied.

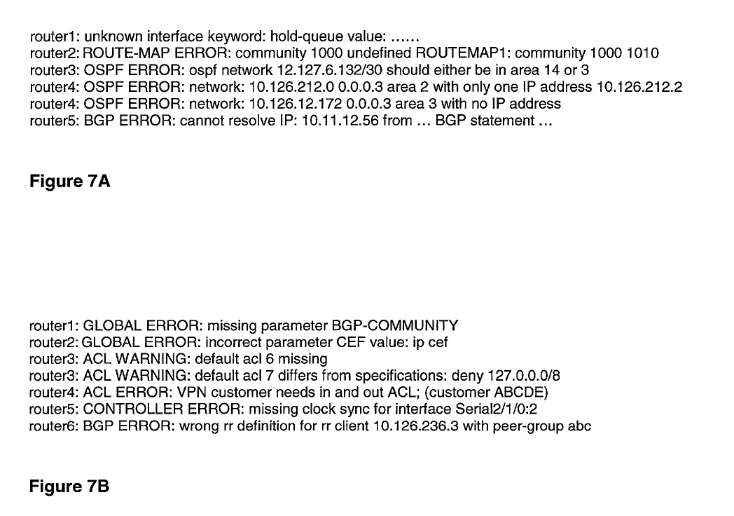

The error checking can generate a variety of error messages, as shown by the sample output in FIG. 7A. The listed checks are by no means all of the checks that can be performed, and they should be considered as merely examples. The first example illustrates how unknown entries can be flagged. In the second example, the error-checking routine flags the fact that community 1000 is referenced but not defined. Both of these errors relate to mistakes in a single router configuration file. The third, fourth, and fifth examples illustrate OSPF problems—a backbone link that has two interfaces with different OSPF areas, the assignment of an OSPF area to a link that has only one interface (i.e., an edge link), and the assignment of an OSPF area to a link that has no interfaces. Detecting these three error requires joining information across multiple router configuration files. The sixth example concerns an eBGP session where the associated router does not have a route to the BGP peer in the neighboring autonomous system. The router configuration file should either define a static route to the remote IP address or specify that the peer is reachable via an attached interface.

A wide variety of consistency checks may be performed; FIG. 7B presents an example. The first two messages show that particular global settings are not set to their desired default values. These kinds of mistakes can arise when a new router is added to the network. The third message concerns a missing access list. Unlike the errors discussed above, this message concerns the absence of a default access list, rather than a reference to a non-existent access-control list. The fourth message identifies an access-control list that differs from the expected configuration. The fifth message identifies a VPN customer for which either the access-control list on the input or on the output side was missing. The sixth message indicates that a particular interface entry is missing a statement related to clock synchronization. The seventh message concerns a misconfigured route-reflector client. Each of the messages identify violations of local conventions, rather than actual configuration errors. Yet, detecting deviations from local policies is critical to the “correct” operation of the network.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. For example, the detailed description has been described with particular regard to the Cisco IOS and IP networks. However, the principles of the present invention could be extended to other formats of router configuration files and other packet-switched network protocols. Such an extension could be readily implemented by one of ordinary skill in the art given the above disclosure.

What is claimed is:

1. A method of analyzing configuration of a packet-switched network comprising the steps of:
receiving configuration information on the packet-switched network;
populating a data model comprising data abstractions of routers in the packet-switched network, interfaces on the routers, links connecting interfaces, routing protocols, and access control, wherein the data model represents the packet-switched network at a level of abstraction appropriate for traffic engineering.

2. The invention of claim 1 further comprising the step of performing a series of error checks on the configuration information in the data model.

3. The invention of claim 2 wherein the data model may be customized to reflect changes in the packet-switched network.

4. The invention of claim 3 wherein the configuration information on the packet-switched network is parsed from router configuration files.

5. The invention of claim 4 wherein dependencies in the router configuration files are identified and the router configuration files are parsed in a pre-specified order reflecting the dependencies.

6. The invention of claim 5 wherein dependencies in the router configuration files are identified and the error checks are processed in a manner reflecting the dependencies.

7. The invention of claim 6 wherein error checks may be customized to check for compliance with network policies.

8. The invention of claim 7 further comprising the step of receiving a list of keywords and wherein the router configuration files are parsed using the list of keywords.

9. The invention of claim 8 wherein commands not identified on the list of keywords are flagged as possible errors.

10. A method of managing a packet-switched network comprising a plurality of routers, each router having a router configuration file, comprising the steps of:
retrieving a plurality of router configuration files, each router configuration file having a plurality of sections;
reading and parsing each section of all of the router configuration files in a pre-specified order reflecting dependencies within the router configuration files while performing error checks on information parsed from the router configuration files; and
populating a data model with the information parsed from the router configuration files.

11. A computer readable medium containing executable program instructions for performing a method on a computer of analyzing configuration of a packet-switched network comprising the steps of:
receiving configuration information on the packet-switched network;
populating a data model comprising data abstractions of routers in the packet-switched network, interfaces on the routers, links connecting interfaces, routing protocols, and access control, wherein the data model represents the packet-switched network at a level of abstraction appropriate for traffic engineering.

12. The invention of claim 11 further comprising the step of performing a series of error checks on the configuration information in the data model.

13. The invention of claim 12 wherein the data model may be customized to reflect changes in the packet-switched network.

14. The invention of claim 13 wherein the configuration information on the packet-switched network is parsed from router configuration files.

15. The invention of claim 14 wherein dependencies in the router configuration files are identified and the router configuration files are parsed in a pre-specified order reflecting the dependencies.

16. The invention of claim 15 wherein dependencies in the router configuration files are identified and the error checks are processed in a manner reflecting the dependencies.

17. The invention of claim 16 wherein error checks may be customized to check for compliance with network policies.

18. The invention of claim 17 further comprising the step of receiving a list of keywords and wherein the router configuration files are parsed using the list of keywords.

19. The invention of claim 18 wherein commands not identified on the list of keywords are flagged as possible errors.
